(19) United States
(12) Patent Application Publication
(10) Pub. No.: US 2025/0110144 A1
(43) Pub. Date: Apr. 3, 2025

(54) FLOW CONTROL SYSTEM FOR CHEMICAL SYNTHESIS DISCOVERY AND PRODUCTION

(71) Applicant: Microflow CVO Inc., Corvallis, OR (US)

(72) Inventor: Richard T Miller, Corvallis, OR (US)

(73) Assignee: Microflow CVO Inc., Corvallis, OR (US)

(21) Appl. No.: 18/900,126

(22) Filed: Sep. 27, 2024

Related U.S. Application Data
(60) Provisional application No. 63/586,186, filed on Sep. 28, 2023.

(51) Int. Cl. G01N 35/10; B01L 3/00; G01N 35/00

(52) U.S. Cl. CPC G01N 35/1016; B01L 3/502746; G01N 35/00871; G01N 35/1065; B01L 2200/16; B01L 2300/0663; B01L 2300/10; B01L 2400/082; G01N 2035/1058

(57) ABSTRACT

A flow control system for chemical synthesis and production integrates automation and real-time data processing. The system comprises a plurality of valves for reagent selection, pumps for fluid transport, inline instruments, and liquid handlers for sample collection. A computer control system manages flow sequences, flow rates, sample volumes, residence times, and wait times. The system utilizes artificial intelligence algorithms to optimize process controls. Reagent selection valves positioned upstream from pumps reduce the number of required pumps and allow the use of low-pressure valves. This configuration enhances efficiency and accuracy in combinatorial chemical experimentation.

### CROSS REFERENCE TO RELATED APPLICATION

This application claims the benefit of U.S. Provisional Application No. 63/586,186, filed Sep. 28, 2023. The prior application is incorporated herein by reference in its entirety.

### FIELD

This disclosure is directed to apparatuses and systems that can be used to perform combinatorial chemical experimentation and synthesis in various flow configurations.

### BACKGROUND

In the field of chemical synthesis and production, achieving precise control over reaction conditions and reagent combinations presents significant challenges. Traditional methods often rely on manual intervention and static setups, which can lead to inefficiencies and inconsistencies in experimental outcomes. The need for automation and flexibility in chemical experimentation has become increasingly apparent, especially in complex combinatorial processes.

Existing systems for chemical synthesis often suffer from limitations such as inflexibility in reagent selection and flow control. These systems typically require multiple pumps and complex configurations to handle various reactant combinations, leading to increased costs and maintenance requirements. Additionally, the lack of real-time data integration and adaptive control mechanisms can result in suboptimal reaction conditions and reduced experimental accuracy.

### SUMMARY

The disclosed system addresses these challenges by providing a flow control system for chemical synthesis and production that integrates advanced automation and real-time data processing. The system utilizes a combination of selector valves, pumps, reaction devices, and a computer control system to manage flow sequences, flow rates, sample volumes, and other parameters. This approach enables precise and automated combinatorial chemical experimentation, enhancing efficiency and accuracy in research and production processes.

According to one aspect, an apparatus for performing combinatorial chemical experimentation and synthesis in flow configurations comprises a plurality of selector valves positioned upstream from respective pumps for reagent selection and flow control, a plurality of pumps for fluid transport, one or more inline instruments for real-time data collection and monitoring, one or more liquid handlers for precise sample collection, and a computer control system configured to manage flow sequences, flow rates, sample volumes, residence times, and wait times, and to utilize artificial intelligence algorithms for process optimization; wherein the apparatus is configured to automatically execute experiment sequences, establish steady-state conditions, and capture data and aliquots.

According to another aspect, the apparatus comprises selector valves that are multi-way valves allowing for multiple reagent combinations.

According to yet another aspect, the apparatus comprises selector valves designed to handle both liquid and gas reagents.

According to another aspect, the apparatus comprises pumps that are variable-speed pumps for precise control of fluid transport.

According to yet another aspect, the apparatus comprises pumps equipped with flow rate sensors for real-time monitoring.

According to another aspect, the apparatus comprises one or more inline instruments that include spectrometers for chemical analysis.

According to yet another aspect, the apparatus comprises inline instruments capable of dynamic light scattering for particle size analysis.

According to another aspect, the apparatus comprises liquid handlers equipped with robotic arms for automated sample collection.

According to yet another aspect, the apparatus comprises a computer control system configured to receive real-time data and utilize artificial intelligence algorithms to determine and instruct changes in process controls.

According to another aspect, the apparatus comprises a computer control system configured to automatically execute experiment sequences, establish steady-state conditions at each experimental cell, and capture data and aliquots.

According to yet another aspect, the apparatus comprises selector valves positioned upstream from respective ones of the plurality of pumps to reduce the number of required pumps and allow the use of low-pressure valves.

According to another aspect, a method for performing combinatorial chemical experimentation and synthesis in flow configurations comprises receiving user-defined parameters including pump configuration, sample volumes, tubing volumes, flow rates, reagent combinations, and reactor temperatures; positioning a plurality of selector valves upstream from respective pumps for reagent selection and flow control; transporting fluids using a plurality of pumps based on the user-defined parameters; collecting real-time data using one or more inline instruments for process monitoring; utilizing a computer control system to manage flow sequences, flow rates, sample volumes, residence times, and wait times; applying artificial intelligence algorithms to optimize process controls and adjust experimental conditions dynamically; executing experiment sequences automatically to establish steady-state conditions and capture data and aliquots; and collecting samples using one or more liquid handlers for precise aliquot sampling.

According to yet another aspect, the method comprises user-defined parameters that further include pressure settings and reagent concentrations.

According to another aspect, the method comprises selector valves that are multi-way valves designed to handle both liquid and gas reagents.

According to yet another aspect, the method comprises pumps that are variable-speed pumps equipped with flow rate sensors for real-time monitoring.

According to another aspect, the method comprises inline instruments that include spectrometers for chemical analysis.

According to yet another aspect, the method comprises inline instruments capable of dynamic light scattering for particle size analysis.

According to another aspect, the method comprises a computer control system configured to integrate with external databases for enhanced data analysis.

According to yet another aspect, the method comprises AI algorithms tailored for specific types of chemical reactions.

According to another aspect, the method comprises artificial intelligence algorithms configured to analyze real-time data to predict optimal reaction conditions and automatically adjust parameters such as flow rates and reagent combinations to enhance experimental outcomes.

The foregoing and other objects, features, and advantages of the invention will become more apparent from the following detailed description, which proceeds with reference to the accompanying figures.

### BRIEF DESCRIPTION OF THE DRAWINGS

The embodiments can be better understood with reference to the following drawings and description.

FIG. 1A discloses an exemplary configuration for a system comprising a plurality of pumps with reagent selector valves upstream from respective pumps.

FIG. 1B discloses another exemplary configuration for a system comprising a plurality of pumps with reagent selector valves upstream from respective pumps.

FIG. 2 discloses another exemplary configuration for a system comprising a plurality of pumps and reagent selector valves.

FIG. 3 discloses an exemplary sample valve sequence.

FIG. 4 discloses an exemplary schematic for control system communications of the disclosed systems.

FIG. 5 discloses an exemplary control system status screen.

FIG. 6 discloses an exemplary experiment setup.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

As used herein, the terms “upstream” and “downstream” are relative to each other with reference to the typical direction of flow of the described systems.

As used herein, a “fluid” can be a liquid or a gas. As used herein, a “liquid” is a substance that is relatively incompressible and has a capacity to flow and to conform to a shape of a container or a channel that holds the substance. It is understood that references to a liquid in the present application may include a liquid that was formed from the combination of two or more liquids. For example, separate reagent solutions may be later combined to conduct designated reactions.

As used herein, the term “in fluid communication” or “fluidically coupled” refers to two spatial regions being connected together such that a liquid or gas may be directed between the two spatial regions. In some cases, the fluidic coupling permits a fluid to be directed back and forth between the two spatial regions. In other cases, the fluidic coupling is unidirectional such that there is only one direction of flow between the two spatial regions (e.g., downstream). For example, a reaction chamber may be fluidically coupled with a reagent container such that a liquid may be transported into the reaction chamber from the reagent container.

As used herein, a “reagent” includes any substance that may be used to obtain a desired reaction. For example, reagents can include biological and/or chemical reagents, catalysts such as enzymes, reactants for the reaction, samples, products of the reaction, other biomolecules, salts, metal cofactors, chelating agents, buffer solutions (e.g., hydrogenation buffer) and wash solutions. The reagent may be delivered, individually in solutions or combined in one or more mixture, to various locations in a fluidic system. For instance, a reagent may be delivered to a reaction chamber.

As used herein, the term “artificial intelligence” or “AI” refers to the application of machine learning and computational techniques to design, optimize, and/or predict chemical reactions and/or synthesize new compounds efficiently.

As used here, the term “aliquot sampling robot” refers to a specialized robotic system designed to automate the process of taking precise and representative samples (aliquots) from a larger liquid or solid sample source.

### Use of AI for Combinatorial Chemical Experimentation and Flow Synthesis

As described herein, the use of artificial intelligence (AI) can play a transformative role in combinatorial chemical experimentation and flow synthesis by enhancing precision, efficiency, and adaptability in the following systems and methods.

The AI algorithms described herein can continuously collect and analyze real-time data from inline instruments monitoring parameters such as temperature, pressure, pH, and spectrometry. This data provides insights into the chemical reactions and their progress. Machine learning techniques enable AI to identify patterns and correlations within the collected data. By recognizing successful reaction conditions, AI can predict the outcomes of similar experiments and suggest optimal parameters.

As described herein, the AI-driven systems dynamically adjust experimental parameters, such as flow rates, reagent combinations, and reaction times, to achieve desired outcomes. This optimization is based on historical data and real-time feedback, ensuring efficient and accurate experimentation. The control systems use AI to automate the execution of experiment sequences, reducing the need for manual intervention. It can establish steady-state conditions, execute experiments, and capture data and aliquots with minimal human oversight. As the system conducts more experiments, the AI algorithms used by the control system continuously learns and refines its models. This adaptive learning allows the system to improve its predictions and optimizations over time, leading to more reliable and consistent results.

In addition, the control systems disclosed herein can integrate with external chemical databases to enhance data analysis and provide additional insights. This integration allows for the incorporation of external knowledge into the experimental process.

The AI algorithms described herein use predictive modeling to simulate potential outcomes of various experimental setups. This capability helps in planning and designing experiments that are more likely to succeed, saving time and resources. During experiments, the system can make real-time adjustments to parameters based on ongoing data analysis. This ensures that the experiments remain on track and adapt to any unexpected changes in conditions. By providing comprehensive data analysis and insights, the systems disclosed herein can support researchers in making informed decisions about experimental directions and modifications. In addition, these AI-driven systems can easily scale to handle complex combinatorial experiments involving numerous variables and conditions. This flexibility is crucial for exploring a wide range of chemical reactions and synthesis pathways.

Overall, as described herein, the AI-driven control systems described herein enhances the capabilities of flow synthesis systems by providing intelligent automation, real-time optimization, and adaptive learning, leading to more efficient and accurate chemical experimentation.

### Exemplary Systems and Methods

The described apparatus is used to perform combinatorial chemical experimentation and synthesis in flow configurations by use of selector valves, pumps, reaction devices, a liquid handler, and a computer control system to manage flow sequences, flow rates, sample volume, residence times, and wait times for purging and achieving steady state. Inline instrumentation provides real time data for process control and can be used for autotuning, machine learning and artificial intelligence (AI) algorithms.

The system components may include, but are not limited to, reagent reservoirs, flow selection valves, pumps, flow rate measurement instruments, temperature measurement instruments, mixers, reactors, heat exchangers, inline analytic instrumentation, liquid handler for sample collection, and valving for product and waste stream control. The active components are all controlled by a computer control system. The control system is user configurable to specify the components used in a synthesis. The user defines the pump configuration, sample volumes, tubing volumes, flow rates, reagent combinations, and reactor temperatures for designed experiment or production settings. Used for experimentation, the system automatically executes the experiment sequence, establishing steady state condition at each experimental cell for data and aliquot capture.

In one embodiment, the reagent selection valves can be positioned upstream from the pumps thereby reducing the number of pumps in the system necessary for a multitude of reactant combinations. Additionally, placing the reagent selection valves upstream from the pump allows low pressure valves and associated hardware to be used.

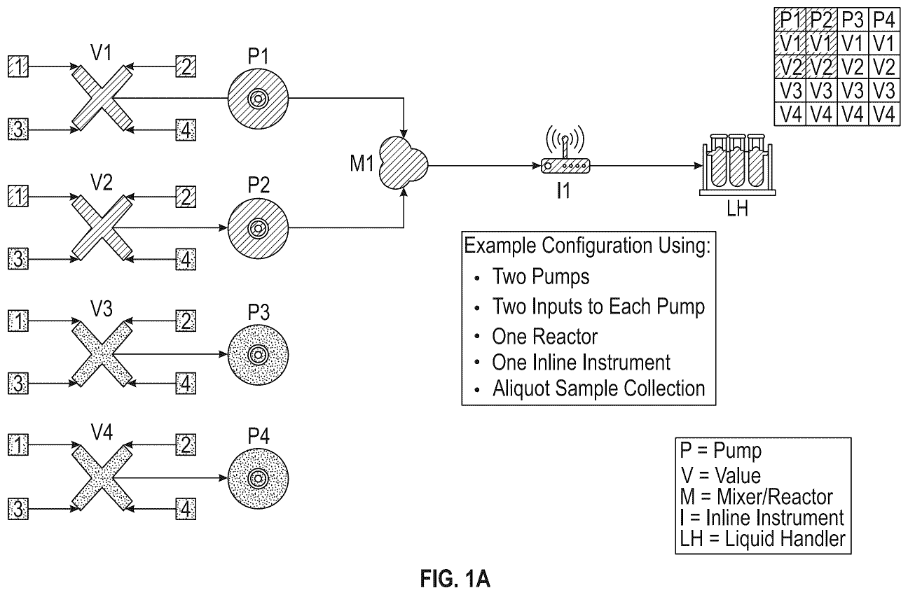

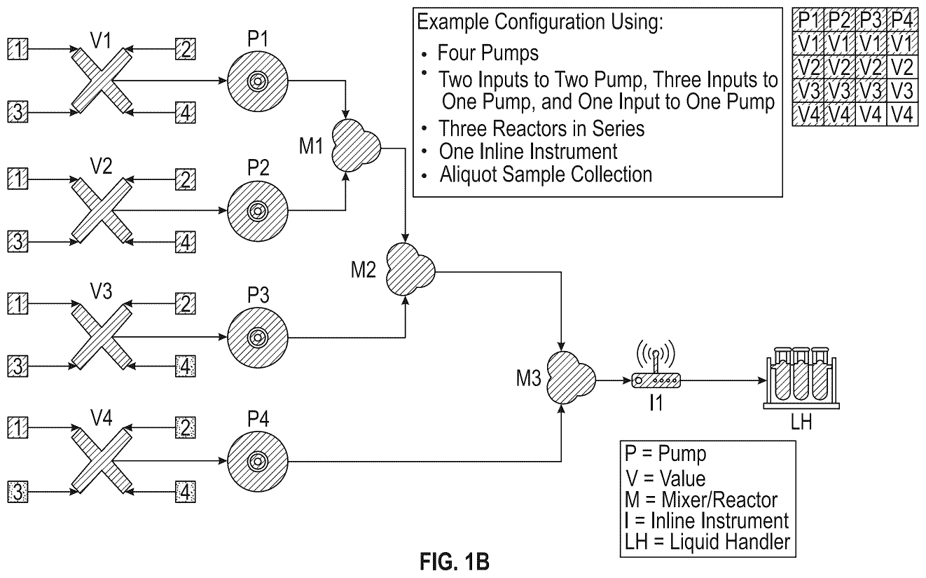

FIGS. 1A and 1B depict exemplary configurations for a multi-pump system with multi-way selector valves, reactors, inline instrumentation, and an aliquot sampling robot (liquid handler). Referring to FIG. 1A, a four-pump system (P1-P4) is illustrated with four-way selector valves (V1-V4), a mixer/reactor (M1), an inline instrument (I1) and a liquid handler (LH). In the system shown in FIG. 1A, the exemplary configuration of a flow control system for chemical synthesis has two active pumps, labeled P1 and P2, each with two active inputs. Upstream from these pumps are selector valves, labeled V1 and V2, which allow for the selection of different reagents. The configuration includes a mixer/reactor, labeled M1, which facilitates chemical reactions. An inline instrument, labeled I1, is integrated for real-time data collection and monitoring. Additionally, a liquid handler, labeled LH, is included for precise sample collection. This setup demonstrates the system's capability to manage multiple reagent combinations efficiently while reducing the number of required pumps by positioning the selector valves upstream.

FIG. 1B illustrates an exemplary configuration of a flow control system for chemical synthesis. The system comprises four active pumps, labeled P1, P2, P3, and P4, each with varying numbers of inputs. Selector valves, labeled V1, V2, V3, and V4, are positioned upstream to allow for the selection of different reagents. The configuration includes multiple downstream mixers/reactors, labeled M1, M2, and M3, which facilitate chemical reactions. An inline instrument, labeled I1, is integrated for real-time data collection and monitoring. Additionally, a liquid handler, labeled LH, is included for precise sample collection. This setup demonstrates the system's capability to efficiently manage multiple reagent combinations while reducing the number of required pumps by positioning the selector valves upstream.

One or more inline instruments provide real-time monitoring and data collection in flow control systems for chemical synthesis. The instruments can include, for example, spectrometers, mass spectrometers, dynamic light scattering instruments, pH meters, conductivity sensors, temperature sensors, pressure sensors, flow rate sensors, and any other suitable measurement device or sensor.

Selector valves allow for the selection of different reagents from multiple sources, enabling diverse chemical reactions without the need for manual intervention. This flexibility is crucial for combinatorial experimentation. By positioning selector valves upstream, the system can reduce the number of pumps needed. This configuration minimizes equipment costs and maintenance requirements. Pumps, especially variable-speed pumps, provide precise control over fluid transport. This precision ensures accurate flow rates, which are essential for maintaining consistent reaction conditions. The combination of selector valves and pumps allows for automated switching between different reagents and flow paths, streamlining the experimental process and reducing downtime. The pumps disclosed herein can have flow rate sensors to enable real-time monitoring and adjustments, ensuring that the system can respond dynamically to changes in experimental conditions. Automated control of valves and pumps, as described herein, can reduce the need for manual handling of reagents, enhancing safety by minimizing exposure to hazardous chemicals. Finally, the selector valves and pumps described herein can be seamlessly integrated with computer control systems, enabling advanced automation and optimization through the AI algorithms and the control system.

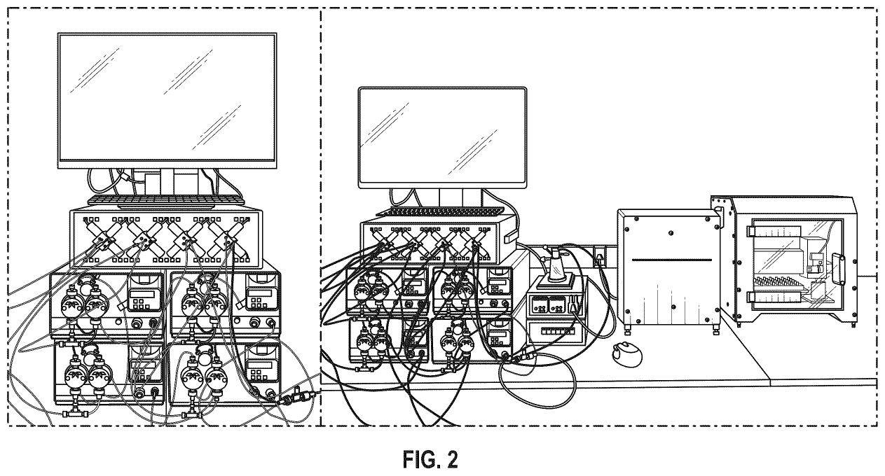

FIG. 2 illustrates a four-pump system with multi-way selector valves, thermocouple modules, tubular reactors, and liquid handlers. This configuration showcases the integration of various components necessary for precise control and monitoring of chemical synthesis processes. The system is designed to handle multiple reagent combinations efficiently, with the selector valves allowing for flexible reagent selection. The thermocouple modules provide temperature monitoring, while the tubular reactors facilitate chemical reactions. Liquid handlers are included for accurate sample collection, ensuring the system's capability to maintain steady-state conditions and optimize experimental outcomes.

From system volumes input by user (tubing volumes between operations, reactor volumes, etc.) and flow rates, the control system calculates time constants to correlate data from various points in the flow path for the same sample volume.

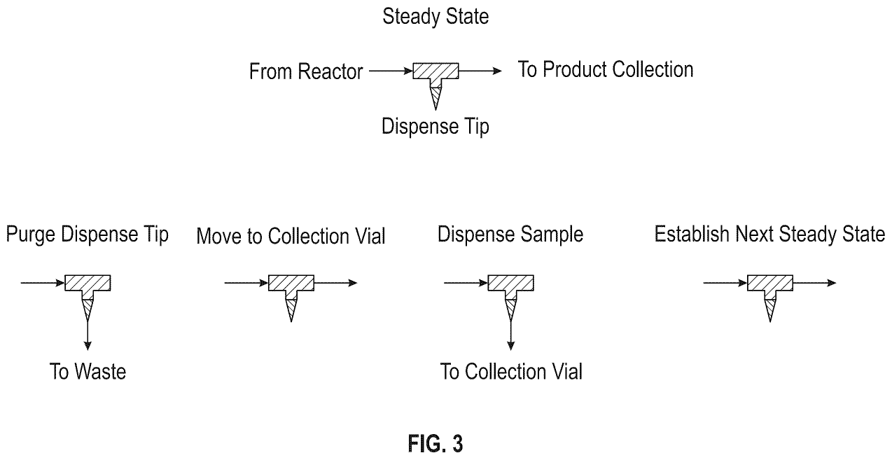

Aliquot sampling can be accomplished using a three port sample valve and a dispense tip. In operation, the product stream flows through the valve to a collection vessel. When steady state is reached, as determined from flow rates, tubing lengths, and/or inline process monitoring data, the sample valve can be switched to the sample port and purges an appropriate amount though the dispense tip into a waste reservoir. The sample valve can then be switched back to the product flow and the liquid handler can move the dispense tip to the appropriate collection vial. The sample valve is then switched to dispense the programmed aliquot volume, then switched back so the product stream flows to the collection vessel. An exemplary sequence is depicted in FIG. 3. This sequence ensures precise and accurate sample collection, maintaining the integrity of the experimental process.

Data from in-line instrumentation can be correlated to sample aliquots via an electronic timestamp. As understating of a particular process matures, algorithms can be implemented that use real-time data from in-line instrumentation for auto-optimization of the experiment, updating design of experiment (DOE) cell conditions based on previous results. As an example, particle size can be monitored using inline instrumentation such as dynamic light scattering. Algorithms compare particle size data to desired outcomes, and define parameters for subsequent experiments accordingly.

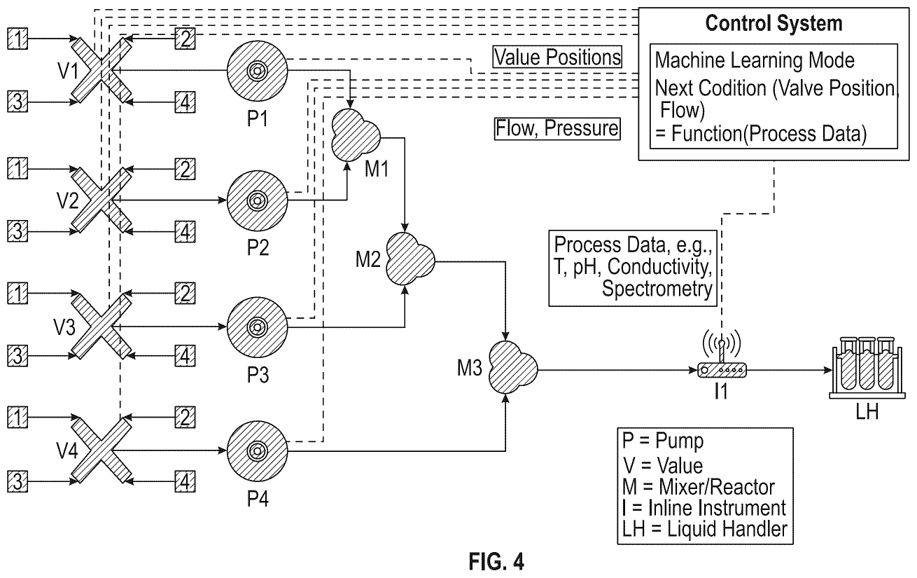

An exemplary communication schematic is shown in FIG. 4. As shown in FIG. 4, a control system can receive and/or control inputs such a process data (e.g., T, pH, conductivity, spectrometry), flow, pressure, valve positions, and determine and control future conditions (e.g., valve position, flow) to alter the conditions and functions of the system. In particular, the control system can provide a machine learning mode that uses AI to select and implement desired outcomes and parameters for subsequent experiments.

The integration of artificial intelligence (AI) in the flow control system for chemical synthesis allows for advanced optimization and automation of experimental processes. AI algorithms analyze real-time data collected from inline instruments, which monitor various parameters such as temperature, pH, conductivity, and spectrometry. This data provides insights into the ongoing chemical reactions and their outcomes.

AI leverages machine learning techniques to identify patterns and correlations within this data, enabling the system to predict how changes in parameters might affect the results. For instance, if a particular reagent combination leads to a desired product yield, the AI can recognize this pattern and adjust future experiments to replicate or enhance these conditions.

Once the AI determines the optimal parameters, such as flow rates, reagent combinations, and reaction conditions, it can automatically implement these adjustments in subsequent experiments. This continuous feedback loop allows the system to refine its processes dynamically, improving efficiency and accuracy over time.

This approach minimizes the need for manual intervention, reducing human error and increasing the speed of experimentation. By continuously learning from each experiment, the AI-driven system can adapt to new challenges and optimize chemical synthesis processes, ultimately leading to more reliable and consistent results in research and production.

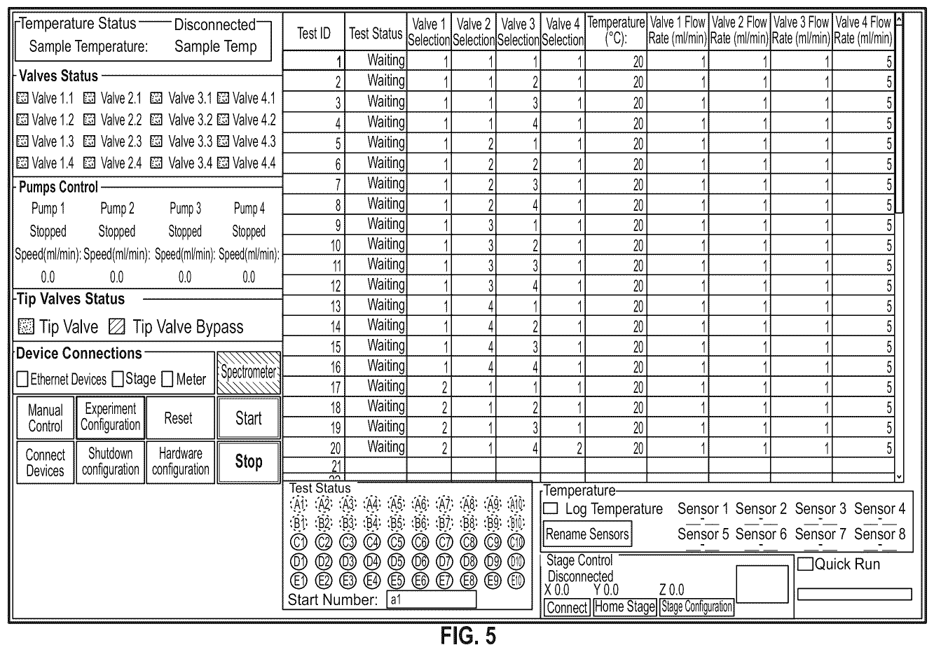

An exemplary control system status screen is depicted in FIG. 5. The screen includes various components such as temperature settings, sample information, valve status, and system controls. The control system status screen provides a comprehensive overview of the system's operational parameters and allows for real-time monitoring and adjustments.

The temperature settings section displays the current temperature readings and allows for input of desired temperature values. This section ensures precise control over the thermal conditions within the system, which is necessary for maintaining optimal reaction environments.

The sample information section provides details about the samples being processed, including sample IDs and associated parameters. This section facilitates accurate tracking and management of samples throughout the experimental process.

The valve status section indicates the current positions of various valves within the system. This information is necessary for understanding the flow paths and ensuring that the correct reagents are being directed to the appropriate locations.

The pump controls section in FIG. 5 include the current status of the pumps (e.g., shown as “stopped”), including controls for adjusting flow rates, starting and stopping pumps, and monitoring pump status to ensure precise fluid transport within the system.

The system controls section includes options for starting, stopping, and adjusting various system operations. This section allows users to interact with the system, making necessary changes to optimize performance and achieve desired experimental outcomes.

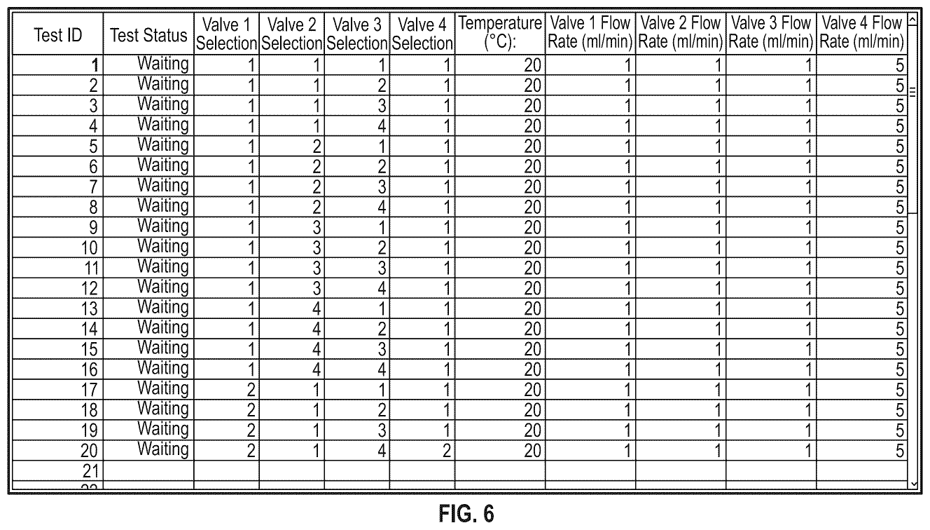

An exemplary experiment setup is shown in FIG. 6. The figure includes components such as Valve 1, Valve 2, Valve 3, Valve 4, Temperature, Valve 1 Flow, Valve 2 Flow, Valve 3 Flow, and Valve 4 Flow. The setup demonstrates the configuration and status of these components during an experimental process.

Valve 1 is responsible for selecting specific reagents for the experiment. The selection process is important for determining the flow path and ensuring the correct reagents are used in the reaction. The status of Valve 1 is indicated in the figure, showing the operational state of Valve 1 during the experiment.

Valve 2 functions similarly to Valve 1, providing additional options for reagent selection. This valve enhances the flexibility of the system by allowing multiple reagent combinations. The figure displays the status of Valve 2, indicating the role of Valve 2 in the experimental setup.

Valve 3 offers further reagent selection capabilities, contributing to the system's ability to handle complex chemical processes. The figure illustrates the status of Valve 3, highlighting the involvement of Valve 3 in the experiment.

Valve 4 is included in the setup to provide additional reagent selection and flow control. The figure shows the status of Valve 4, emphasizing the function of Valve 4 in managing the flow of reagents. In this embodiment, for example, Valve 4 flow can be a dilution stream.

The Temperature component is for maintaining optimal reaction conditions. The figure indicates the temperature settings used during the experiment, ensuring precise control over the thermal environment.

Valve 1 Flow, Valve 2 Flow, Valve 3 Flow, and Valve 4 Flow represent the flow rates of reagents through each respective valve. The figure details these flow rates, demonstrating the system's capability to manage fluid transport accurately.

In some embodiments, the system can be operated to establish steady state, take measurements, and aliquot samples, then adjust input parameters for the next condition. In another embodiment, the system can be operated to dynamically sweep a parameter (e.g., temperature, flow ratio) through a range of values sampling inline continuously and collecting aliquots at time intervals.

The systems and methods described herein can enable precise and automated combinatorial chemical experimentation and synthesis in flow configurations, offering improved efficiency and accuracy in chemical research and production processes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An apparatus for performing combinatorial chemical experimentation and synthesis in flow configurations, comprising:
a plurality of selector valves positioned upstream from respective pumps for reagent selection and flow control;
a plurality of pumps for fluid transport;
one or more inline instruments for real-time data collection and monitoring;
one or more liquid handlers for precise sample collection; and
a computer control system configured to manage flow sequences, flow rates, sample volumes, residence times, and wait times, and to utilize artificial intelligence algorithms for process optimization;
wherein the apparatus is configured to automatically execute experiment sequences, establish steady-state conditions, and capture data and aliquots.

2. The apparatus of claim 1, wherein the selector valves are multi-way valves allowing for multiple reagent combinations.

3. The apparatus of claim 2, wherein the selector valves are designed to handle both liquid and gas reagents.

4. The apparatus of claim 1, wherein the pumps are variable-speed pumps for precise control of fluid transport.

5. The apparatus of claim 4, wherein the pumps are equipped with flow rate sensors for real-time monitoring.

6. The apparatus of claim 1, wherein the one or more inline instruments include spectrometers for chemical analysis.

7. The apparatus of claim 6, wherein the inline instruments are capable of dynamic light scattering for particle size analysis.

8. The apparatus of claim 1, wherein the liquid handlers are equipped with robotic arms for automated sample collection.

9. The apparatus of claim 1, wherein the computer control system is configured to receive real-time data and utilize artificial intelligence (AI) algorithms to determine and instruct changes in process controls.

10. The apparatus of claim 1, wherein the computer control system is configured to automatically execute experiment sequences, establish steady-state conditions at each experimental cell, and capture data and aliquots.

11. The apparatus of claim 1, wherein the selector valves are positioned upstream from respective ones of the plurality of pumps to reduce the number of required pumps and allow the use of low-pressure valves.

12. A method for performing combinatorial chemical experimentation and synthesis in flow configurations, comprising:
receiving user-defined parameters including pump configuration, sample volumes, tubing volumes, flow rates, reagent combinations, and reactor temperatures;
positioning a plurality of selector valves upstream from respective pumps for reagent selection and flow control;
transporting fluids using a plurality of pumps based on the user-defined parameters;
collecting real-time data using one or more inline instruments for process monitoring;
utilizing a computer control system to manage flow sequences, flow rates, sample volumes, residence times, and wait times;
applying artificial intelligence algorithms to optimize process controls and adjust experimental conditions dynamically;
executing experiment sequences automatically to establish steady-state conditions and capture data and aliquots; and
collecting samples using one or more liquid handlers for precise aliquot sampling.

13. The method of claim 12, wherein the user-defined parameters further include pressure settings and reagent concentrations.

14. The method of claim 12, wherein the selector valves are multi-way valves designed to handle both liquid and gas reagents.

15. The method of claim 12, wherein the pumps are variable-speed pumps equipped with flow rate sensors for real-time monitoring.

16. The method of claim 12, wherein the inline instruments include spectrometers for chemical analysis.

17. The method of claim 16, wherein the inline instruments are capable of dynamic light scattering for particle size analysis.

18. The method of claim 12, wherein the computer control system is configured to integrate with external databases for enhanced data analysis.

19. The method of claim 12, wherein the AI algorithms are tailored for specific types of chemical reactions.

20. The method of claim 12, wherein the artificial intelligence algorithms are configured to analyze real-time data to predict optimal reaction conditions and automatically adjust parameters such as flow rates and reagent combinations to enhance experimental outcomes.
